(19) United States
(12) Patent Application Publication
(10) Pub. No.: US 2025/0202174 A1
(43) Pub. Date: Jun. 19, 2025

(54) BUSBAR AND TRUNKING RAIL FOR LUMINAIRES OR OTHER ELECTRICAL DEVICES

(71) Applicant: Zumtobel Lighting GmbH, Dornbirn (AT)

(72) Inventors: Gerald Ladstätter, Dornbirn (AT); Matthew Ince, Dornbirn (AT)

(73) Assignee: Zumtobel Lighting GmbH, Dornbirn (AT)

(21) Appl. No.: 18/849,812

(22) PCT Filed: Mar. 29, 2023
(86) PCT No.: PCT/EP2023/058103

§ 371 Date: Sep. 23, 2024

(30) Foreign Application Priority Data
Apr. 28, 2022 (EP) 22170491.9

(51) Int. Cl. H01R 25/14

(52) U.S. Cl. CPC H01R 25/145

(57) ABSTRACT

A busbar (110, 120) for luminaires or other electrical devices has a plurality of busbar sections which can be connected to one another and which each have a plurality of lines (111, 121), running in a longitudinal direction, for power supply and/or signal transmission, which lines (111, 121) are arranged in grooves (113, 123), open towards a contacting side, of a line-receiving structure (112, 122) consisting of an insulating material. Electrical contacts (50) are arranged in the connecting region of two successive busbar sections, to which contacts (50) in each case the ends of two lines (111, 121) to be connected to one another can be connected and which contacts (50) form a contacting surface (51) accessible from the contacting side, wherein at least one of the electrical contacts (50) is removable in order to interrupt the connection of the corresponding line (111, 121) between two successive busbar sections.

### CROSS-REFERENCE TO RELATED APPLICATION

The present application is the U.S. national stage application of international application PCT/EP2023/058103 filed Mar. 29, 2023, which international application was published on Nov. 2, 2023 as International Publication WO 2023/208503 A1. The international application claims priority to European Patent Application No. 22170491.9, filed Apr. 28, 2022.

### TECHNICAL FIELD OF THE INVENTION

The present invention relates to a busbar for luminaires and/or other electrical devices as well as to a trunking system comprising at least one corresponding busbar.

### BACKGROUND OF THE INVENTION

Busbars are characterized by the fact that the wires or lines used for the power supply or for other purposes are accessible or contactable over at least a larger elongated section, which opens up the possibility of being able to position consumers to be connected more or less flexibly at least over this section. Thus, the consumers—for example, the luminaires of a continuous-row lighting system—can not only be arranged at fixed predetermined positions, but can be freely positioned at almost any desired location.

A known trunking system in which such busbars are used is distributed by the applicant under the name “TECTON”. A special feature of this trunking system is that the cables used for the power supply provide a normal mains supply voltage of e.g. 250 volts and are nevertheless accessible for contacting without interruption over the entire length of the trunking system. This is achieved, among other things, by arranging the lines in a line-receiving structure consisting of an insulating material, which line-receiving structure forms grooves open towards a contacting side. From this contacting side, the lines can then be contacted by luminaires or other consumers connected to the trunking system, whereby the grooves as well as the individual components of the line-receiving structure are, however, designed in such a way that accidental contact with the current-carrying lines is prevented. In this way, the corresponding safety regulations, by which accidental contact with the lines is to be prevented, are fulfilled.

The lines of the busbar usually should extend over the entire length of the trunking system. This applies in particular to the phases and the neutral conductor of the power supply, via which a voltage of, for example, 230 volts is provided to the luminaires or other electrical devices. As it is not practicable to manufacture the line-receiving structure with the corresponding lines in a plurality of different lengths, trunking rail elements equipped with sections of a bus bar are usually provided in only a few standard lengths (for example in lengths of 1 m, 2 m and 3 m), wherein these trunking rail elements as well as their bus bar sections are then connected to each other when the trunking system is installed. However, in the “TECTON” system mentioned above, also in the connecting region of two consecutive trunking rail elements specific electrical contacts are used which ensure that also in these connection regions luminaires or other electrical devices are provided with a contacting possibility. In this way, the line sections of the trunking rail elements together with the electrical contacts form continuous, contactable electrical lines from the beginning of the busbar up to its end, which is a unique feature of this known trunking system.

On the other hand, in specific situations, it might be necessary to interrupt at least some of the lines of the busbar in order to form sub-sections which are not electrically connected to each other. This situation could occur for example in case that some of the lines of the busbar are used to provide a safety extra low voltage (SELV) which directly can be used by electrical devices connected to the busbar. For example, specific luminaires or other light sources could be used having LEDs which directly use the safety extra low voltage provided by the busbar. These devices are less expensive because they then do not require special components such as converters to convert the normal supply voltage of 230 volts to a lower voltage for driving the LEDs. Using some lines of the busbar to provide such a protective extra-low voltage thus increases the flexibility of the entire system. However, as the length of a line providing SELV is limited, it usually makes no sense to use for this purpose a busbar line which extends over the entire length of a trunking system. In this situation, it might be necessary to interrupt the corresponding lines of the busbar in order to obtain several sub-sections which are then individually supplied with safety extra low voltage.

Another scenario to interrupt the lines of a trunking system would be to interrupt the lines used for data communication. As the number of devices that can be individually addressed in the known DALI standard is limited, interrupting the busbar lines again might be helpful since separate communication busses could be realized which increases the number of devices that can be individually contacted.

### SUMMARY OF THE INVENTION

Accordingly, it is an object of the present invention to provide a busbar which makes it possible to individually interrupt at least some lines of the busbar in order to realize separate busbar sub-sections.

In accordance with the present invention, a busbar for luminaires or other electrical devices is provided,
having a plurality of busbar sections which can be connected to one another and which each have a plurality of lines running in the longitudinal direction for power supply and/or signal transmission, which lines are arranged in grooves open towards a contacting side, of a line-receiving structure consisting of an insulating material,
wherein electrical contacts are arranged in the connection region of two successive busbar sections, to which electrical contacts the ends of two lines to be connected to one another can be connected and which contacts form a contacting surface accessible from the contacting side,
and wherein at least one of the electrical contacts is removable in order to interrupt the connection of the corresponding line between two successive busbar sections.

Accordingly, the present invention is based on the idea that the electrical contacts which actually are used to provide a continuous contacting possibility over the entire length of the trunking system are arranged in such a way that these contacts can be individually removed in case it is decided that the corresponding line should be split in separate sections. This can be easily done while installing the trunking system, wherein in particular it is not necessary to replace parts of the busbar by replacement elements or even to cut the lines in order to obtain the desired subdivision.

Preferably, a plurality of electrical contacts are arranged in a connector element, which connector element has groove-like recesses corresponding to the grooves of the line-receiving structure for the lines, via which recesses the contacting surfaces of the electrical contacts are accessible. This connector element preferably consists of a housing of an insulating material and is comparable to connector elements which have been used in the past in corresponding trunking systems. However, in contrast to this former versions, the new connector element used according to the present invention is open or can be opened at its rear side opposite the recesses, so as to be able to selectively remove the at least one electrical contact. This solution allows the user to remove the electrical contact(s) without the need of any tools when installing the trunking system. In particular, the back of the connector element can be provided in such a way that it is closable by a removable cover or lid, preferably by a cover pivotally mounted on the mechanical connector.

The present invention also provides a trunking rail for luminaires or other electrical devices which trunking rail comprises a trunking rail profile and at least one busbar held by the trunking rail profile as mentioned above. Preferably, the trunking rail profile is formed by a plurality of trunking rail elements arranged one behind the other, wherein the electrical contacts are arranged in the transition region of two successive trunking rail elements.

According to a preferred embodiment of the present invention, the two successive trunking rail elements are mechanically connected to one another by a mechanical connector element, wherein the removable electrical contact is arranged on the mechanical connector. In particular, the mechanical connector has at least one wall on which the electrical contacts are arranged, wherein the wall has an opening which allows access to the removable electrical contact.

The advantage of the solution explained above is that the selected electrical contacts can be removed before two consecutive trunking rail elements are connected to one another. In this situation, removing the electrical contact is easily performed as the electrical contact is only connected to one end portion of a corresponding line. The solution also ensures that interrupting the lines is realized before the busbar is connected to external power supplies.

The safety can be further improved, in case the mechanical connector and the trunking rail elements are provided in such a way that, when joined together, the trunking rail elements laterally enclose the mechanical connector in such a way that access to the electrical contacts is prevented. This means that once the complete trunking system has been assembled, the removable electrical contacts are no longer accessible and there is no longer any risk of individual lines being touched inadvertently.

Preferably, the lines including the removable electrical contacts are used to provide a safety extra low voltage or are used for communication purposes, in particular for the communication according to the DALI standard.

Similar to known trunking systems, the trunking rail profile according to the present invention preferably has a profile which is U-shaped or H-shaped with two side walls, wherein on the inner sides of at least one side wall a busbar in accordance with the present invention is arranged.

### BRIEF DESCRIPTION OF THE DRAWINGS

In the following, the present invention is discussed in more detail with reference to the drawings:

FIG. 1 shows a sectional view of a trunking rail system comprising two busbars.

FIG. 2 shows a perspective view of an end portion of a trunking rail element with the mechanical connector.

FIG. 3 shows a perspective view of an electrical contact which is used in the inventive embodiment.

FIG. 4 shows a portion of a luminaire or of another electrical device which is to be attached to the inventive trunking rail system.

FIG. 5 shows the perspective view of an end portion of an inventive trunking rail element with a mechanical connector, wherein the mechanical connector together with the connector element allows removing at least some of the electrical contacts.

FIG. 6 shows the mechanical connector of the embodiment of FIG. 5, wherein the lid of the connector connector is opened.

FIG. 7 shows the perspective view of an end portion of a mechanical connector with a closed connector element according to a second inventive embodiment.

FIG. 8 shows the mechanical connector of the second embodiment of FIG. 7, wherein the lid of the connector element is opened.

### DETAILED DESCRIPTION OF EXEMPLARY EMBODIMENTS

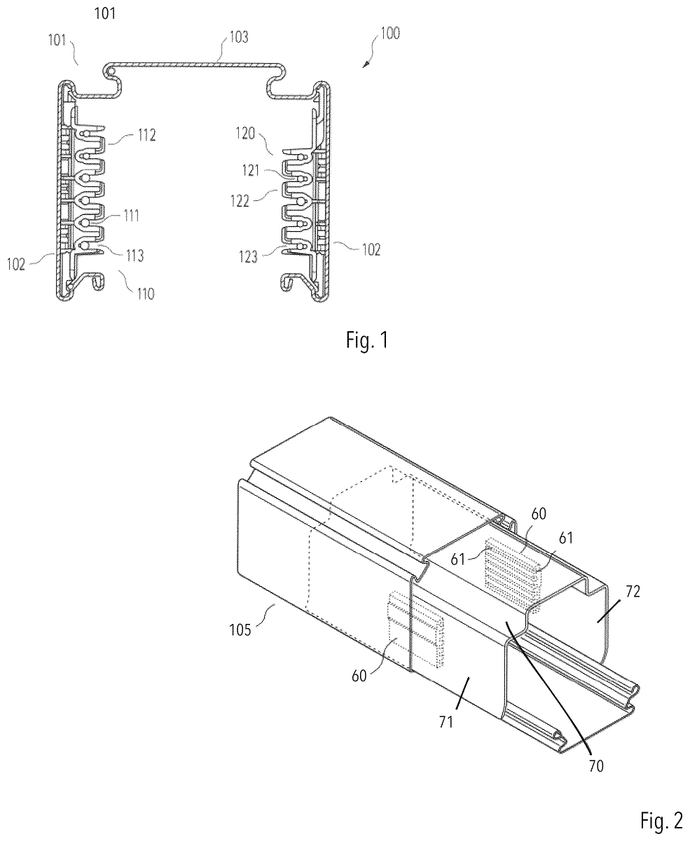

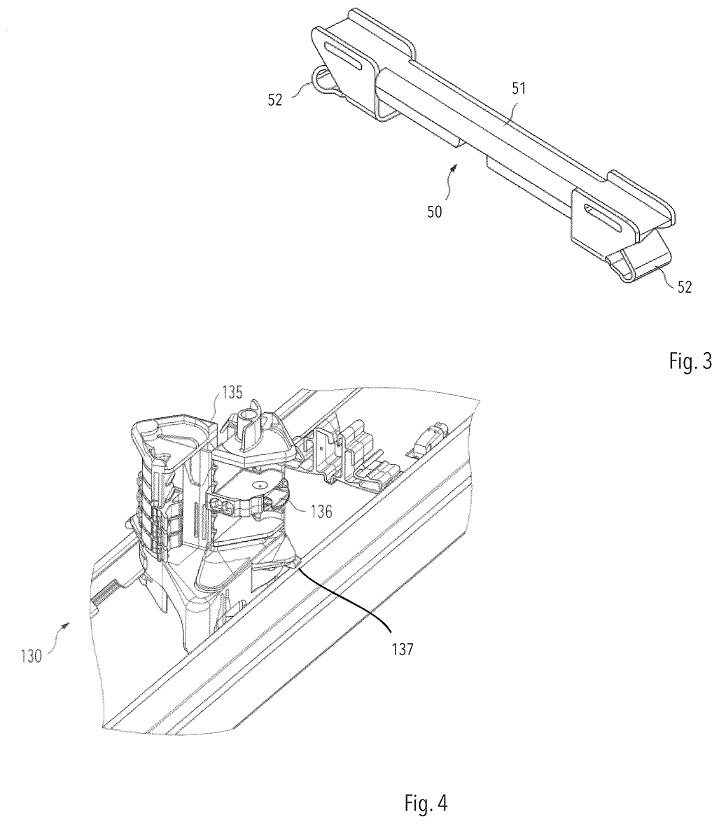

As already mentioned, the present invention represents in particular a further development of the known “TECTON” system. Before the solution according to the present invention is described in more detail, the basic design of this known trunking rail system will therefore be explained below with reference to FIGS. 1-4. Here, FIGS. 1 and 2 show views of the trunking rail with the busbars arranged therein. FIGS. 3 shows an electrical contact used to connect the lines of two successive busbar sections and FIG. 4 shows the design of a luminaire connected or to be connected to this trunking rail system.

It can be seen here first of all that in the shown trunking rail system 100 an elongate trunking rail profile 101 of U-shaped cross-section and open at the bottom is used, which with its two side walls 102 and the upper connecting wall 103 delimits an elongate receiving space which is accessible from the underside via an elongate coupling opening.

On the inner sides of both side walls 102, in the case shown, a busbar 110 or 120 is arranged in each case (in FIG. 2, which only shows the trunking rail profile 101, these busbars are not shown), which in each case has several un-insulated wires or lines 111, 121 running in the longitudinal direction. These lines 111, 121 are arranged in elongated channels or grooves 113, 123 of a line-receiving structure 112, 122 consisting of an insulating material. The channels 113, 123 here provide for a secure mounting of the lines 111, 121 in such a way that they cannot be accidentally touched. At the same time, however, the channels 113, 123 are each designed to be open towards the interior of the trunking rail profile 101, so that contacting of the conductors 111, 121 is possible.

A luminaire 130 to be connected to this trunking rail system 100 then has at least one rotatably mounted contacting element 135, as can be seen in FIGS. 4. To connect the luminaire 130 to the trunking rail system 100, the luminaire 130—or any other electrical device which is to be used with the trunking rail system 100—is placed against the elongate trunking rail profile 101 from the underside. The contacting element 135 is inserted into the receiving space of the trunking rail profile 101 via the elongate coupling opening and then rotated by about 45°. Contacts 136 arranged on the contacting element 135 are designed in such a way that they are swung out laterally by the rotation and then engage in the receiving channels 113, 123 of the two busbars 110, 120 in order to contact the corresponding lines 111, 121. At the same time, latching elements 137 of the luminaire 130 also engage in corresponding recesses of the trunking rail profile 101 in order to mechanically fix the luminaire 130 to the trunking rail profile 101.

In the known “TECTON” system, the longitudinal line-receiving structures 112, 122 are formed by a plurality of individual line-receiving elements which are connected to each other to form a longitudinal structure. These elements engage with each other such that also in the connection region of two successive elements the channels for safely accommodation the lines are formed. In this way, the busbars 110, 120 used in the above trunking rail system 100 could be continuously realized in any desired length.

However, for manufacturing reasons, the line-receiving structures consisting of the insulating material or the trunking rail profile, which represents the supporting element of the continuous-row lighting system, is only manufactured and transported up to a certain length. Accordingly, in the system known from the prior art, corresponding trunking rail elements equipped with sections of a busbar are provided in a limited number of standard lengths, whereby the trunking rail elements as well as the busbar sections must then be connected to each other on site when the continuous-row lighting system is installed.

It is another special feature of the known “TECTON” system is that it is also possible to position luminaires or other electrical devices and contact the lines of the busbars in the area where two successive trunking rail elements and the corresponding busbar sections are connected to each other. This is made possible by the use of special electrical connection contacts, such as those shown in FIG. 3.

FIG. 3 shows a single electrical contact 50 such as is currently used in the “TECTON” system and is known, for example, from EP 1 284 033 B1. This electrical contact 50 consists of an elongated contacting plate 51 bent on its longitudinal sides, the function of which is to take over and pass on the electrical current of the lines that are routed along the busbar. For this purpose, spring contacts 52 are arranged at each end of the contacting plate 51, which enable the end regions of the lines of two busbar sections to be connected to each other to be contacted in a clamping manner.

As FIG. 2 shows, connector elements 60 are also provided in the transition region of two trunking rail elements 105 to be connected to one another (shown here is the end face region of one trunking rail element 105 which is to be connected to a further trunking rail element 105 of identical design) of the continuous-row lighting system, which connector elements 60 serve to accommodate the electrical contacts 50. These connector elements 60 are mode from an insulating material and have groove-like recesses 61 corresponding to the receiving channels 113, 123 the line receiving structure 112, 122, the electrical contacts 50 being inserted into the connector element 60 in such a way that the contacting plates 51 of the electrical contacts 50 are accessible via the groove-like recesses 61.

In addition, a mechanical connection of two successive trunking rail elements 105 is achieved by means of a mechanical connector 70. This U-shaped connector 70 is inserted approximately halfway into each of the end portions of the trunking rail elements 105 to mechanically stabilize the resulting structure. The connector elements 60 with the electrical contacts 50 are attached to the inner sides of the two side walls 71, 72 of this mechanical connector 70.

The recesses 61 of the connector element 60 continue the receiving channels 113, 123 of the line-receiving structure 112, 122, and the contacting plate 51 bridges the lines of the busbar sections to be connected to one another. Ultimately, this leads to the fact that there is also a contact possibility for luminaires or other electrical devices to be connected in the connection area of two successive trunking rail elements 105 at any time, so that in the known trunking system there is actually an uninterrupted possibility of contacting along the entire length. Compared to other known systems, this achieves an outstanding flexibility with regard to the possibility of arranging luminaires or other electrical devices.

The uninterrupted contacting possibility along the entire length of the whole trunking rail system is in particular preferred for the lines used for regular power supply, wherein a high voltage of, for example, 230 volt is supplied. For example, the different phases and in particular, the neutral line of the power supply should be uninterrupted in order to ensure that a reliable and secure power supply for the luminaires or other devices is obtained without the risk of shortcuts.

On the other hand, in specific situations breaks or interruptions in at least some of the lines of the busbar(s) might be beneficial. As mentioned earlier, reliable power supply to electrical equipment is possible only over a limited length if some of the lines are used to supply a safety extra low voltage (SELV). Also, the number of devices that can be supplied via a single SELV circuit is limited compared to a high voltage power supply circuit. On the other hand, the use of such SELV devices has some advantages, such as avoiding the need for converters or other complex and expensive drivers for the devices (e.g. LED light sources). In this situation, there is a desire to give the user the possibility to divide the lines of a busbar in specific sub-sections, which are then individually provided with SELV.

Another scenario is that the lines used for DALI communication are splitted in order to obtain several individual DALI sub-buses following each other in the longitudinal direction. This solution allows an increase in the number of luminaires and/or other devices which can be individually addressed from a central control unit by using DALI communication.

The present invention now provides a solution which increases the flexibility and consequently reduces planning complexity. In particular, with the new solution the user is able to split specific lines of the busbar(s) only when installing the trunking rail system. It is, however, not required to order and use specific electrical connection solutions that correspond to the final design of the whole trunking system, i.e., to the way how the different lines of the busbar(s) are finally used during operation of the trunking rail system.

According to the inventive solution, the capability to split the lines of a busbar is included in the connector elements used to connect busbar sections of two successive trunking rail elements, which means that no additional parts or elements need to be used in order to introduce breaks in the lines.

The inventive solution makes use of the elements discussed in particular with respect to FIGS. 2 and 3. Again, a connector element consisting of an insulating material is used to hold a plurality of electrical contacts, which are arranged to connect the lines of two successive busbar sections. However, now the electrical contacts can be individually removed from the connector element in case it is desired to interrupt the corresponding line of the busbar.

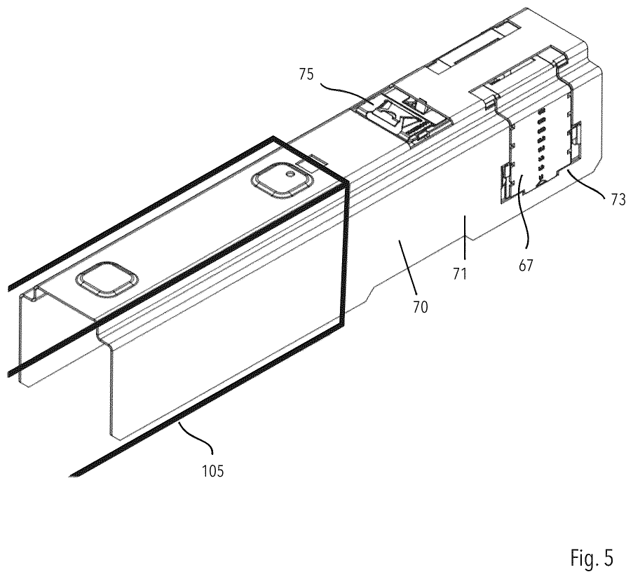

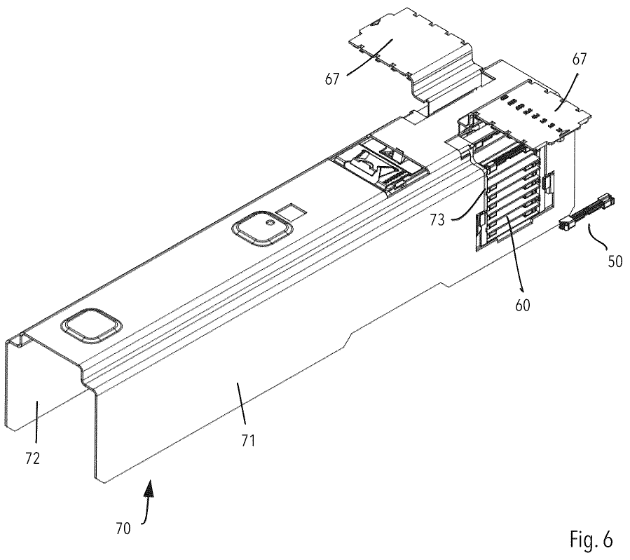

FIGS. 5 and 6 show this concept according to the invention in detail, with the identical elements being given the same reference signs.

Similar to FIG. 2, the end portion of one—schematically represented—trunking rail element 105 is shown in FIG. 5 which trunking rail element 105 is provided with a mechanical connector 70 used to mechanically connect two successive trunking rail elements 105. This mechanical connector 70 is at least in part—preferably by approximately 50%—inserted into the end portion of the trunking rail element 105, the other part of the mechanical connector 70 extending over the end of the trunking rail element 105 and being inserted into the next trunking rail element when installing the whole system.

To improve the stability of the arrangement, mechanical connector 70 is secured to the trunking rail element 105 by clinching or other means. In addition, the top surface 103 of the free running portion of the mechanical connector 70 is provided with additional clamping elements or latching elements 75 that interact with the next trunking rail element to be connected, which improves the connection with the following trunking rail element once it is slid over the free running portion of the mechanical connector 70.

This part of the mechanical connector 70 which extends over the end of the trunking rail element 105 also accommodates connector elements 60 with electrical contacts 50, similar to the solution known in the prior art and shown in FIG. 2. These connector elements 60 are already connected to the lines extending along the trunking rail element 105 to which the mechanical connector 70 element is attached. In case the following trunking rail element is slid over the mechanical connector 70 for a mechanical connection, also the corresponding lines of this following trunking rail profile will be inserted in the corresponding spring contacts 52 of the electrical contacts 50 in order to obtain the electrical connection of the busbar lines extending through the trunking rail profiles 105.

However, as shown in FIG. 6, mechanical connector 70 and the connector element 60 holding the electrical contacts 50 are configured in such a way that now electrical contacts 60 can be individually removed if desired. In order to provide this option, at first the connector element 60 is adapted on its rear side opposite the recesses 61 which correspond to the grooves 113, 123 of the line-receiving structures 112, 113 such that the electrical contacts 50 are accessible and can be selectively removed in case the corresponding line of the busbar 120, 130 shall be splitted or interrupted. While in the prior art the rear side of the connector element 60 is completely closed and protected by the corresponding sidewall 71, 72 of the mechanical protector 70, now access to the electrical contacts 50 is provided allowing to remove one or several of the contacts 50 without the need for the use of any tools.

In this regard, it has to be noted that according to the inventive solution, most preferably electrical contacts 50 are removed from the connector element 60 before the trunking rail element 105 is connected with another one. In this situation, electrical contacts 50 which are to be removed are only connected on one side with a corresponding line and therefore can be easily removed from the connector element 60 by simply pulling the electrical contact 50 out from the corresponding chamber in connector element 60 and pulling the spring contact 52 off from the wire.

In order to protect in particular the electrical contacts 50 which are to remain in the connector element(s) 60, the rear side of the connector element(s) 60, which is accessible via a corresponding opening 73 in the side wall 71 of the mechanical connector 70, is preferably not permanently open. As shown in FIGS. 5 and 6, the connector element(s) 60 preferably have removable lids 67, which can be completely removed or—in the present case—swivelled up in order to obtain access to the interior of the connector element(s) 60. The solution shown in the figures is a preferred solution as the openable lids 67 are nevertheless permanently connected to the connector element(s) 60. However, as an alternative solution, it would also be feasible to provide lids 67 which are locked to the remaining housing of connector element(s) 60 and can be removed (for example by using a screwdriver) to open back of connector element(s) 60 and to obtain access to the electrical contacts 50. In both variants, the lids 67 are preferably secured to the connector element(s) 60 in the closed state to prevent accidental opening of the rear side of the connector elements (60).

Of course, as an alternative solution, it would also be possible to use rear-opened connector elements 60 and to provide mechanical connectors 70 that have hinged or removable covers that can be selectively opened to gain access to the connector elements 60 and to remove some of the electrical contacts 50.

As mentioned before, the removal of the electrical contacts 50 should to take place before the trunking rail element 105 is connected to a following trunking rail element 105. In the solution shown in the figures, this provides an additional safety mechanism as the extending portion of the mechanical connector 70 which accommodates the connector elements 60 with the removable contacts 50 is completely covered by the following trunking rail element 105 once the two trunking rail elements 105 have been connected to each other. In this situation, access to the removable contacts 50 is no longer available and there is thus not the risk that current carrying lines are touched during operation of the trunking system.

Accordingly, the present invention provides a very fast and efficient possibility to split some lines of a busbar system in case it is desired to obtain several sub-systems. The flexibility for the customers is significantly increased as the customer only has to decide whether a line is split just before the final installation of the system. An additional advantage is that the customer is completely free to decide which one of the lines of the busbar shall be split.

On the other hand, at least some lines of the busbar will most likely never be interrupted or split in order to ensure a reliable function of the trunking system. This is for example the case for the lines providing the regular power supply of, for example, 230 volt. In order to avoid a situation that a customer unintentionally interrupts these lines, the opening in the mechanical connector and/or the connector elements at their rear sides could be designed in such a way that for only a limited number of electrical connectors access can be obtained. Only these electrical contacts then can be removed by the customer, whereas other electrical contacts permanently remain within the connector element, ensuring that the corresponding line extends from one end of the trunking rail to the other end without any interruption.

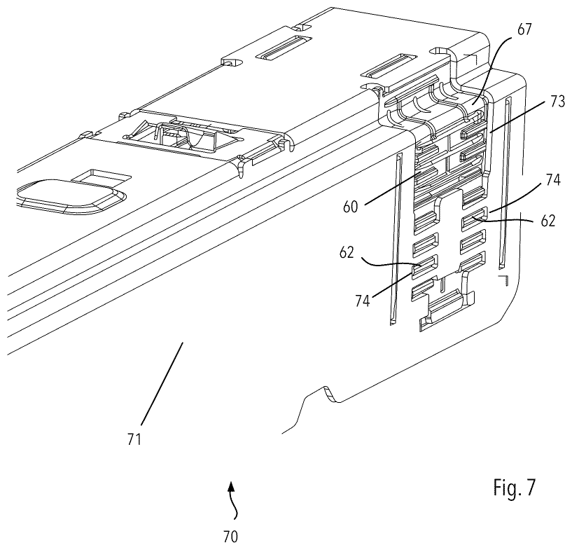

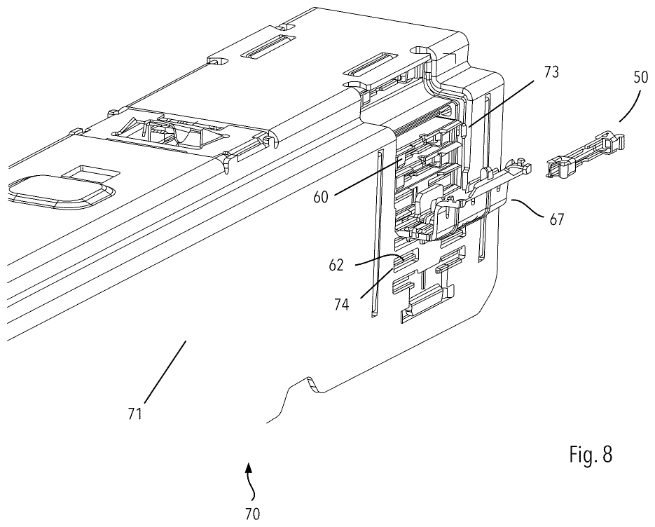

This solution is shown in FIGS. 7 and 8, which show an alternative inventive design of a mechanical connector 70 and a corresponding connector element 60 wherein identical reference signs are used. Both figures only show the relevant end portion of the mechanical connector 70 which accommodates connector element(s) 60; the remaining part of the mechanical 70 connector is similar to the embodiment shown in FIGS. 5 and 6 and is again inserted into the end portion of a trunking rail element 105.

Again, the mechanical connector 70 has an opening 73 on its side wall 71 which opening 73 provides access to the rear side of the connector element 60 which is arranged on the inner side of the side wall 71. Now, however, this opening 73 is configured to allow access to only a portion of the connector element 60, in the embodiment shown, the upper portion of the connector element 60 which receives, for example, the three upper electrical contacts 50. The lower portion of the rear side of connector element 60 is now covered by the sidewall 71 of mechanical connector 70 and can no longer be accessed once the connector element 60 has been attached to the inner side of the mechanical connector 70. As can be seen in both figures, the side wall 71 of mechanical connector 70 has small openings or slots 74 that are engaged by small projections 62 extending from the rear of connector element 60. Although this measures are not essential to implement the inventive concept, this openings/slots 74 and corresponding projections 62 help to secure the connector element 60 in the desired position on the mechanical connector 70.

Similar to the embodiment of FIGS. 5 and 6, that portion of connector element 60 that is accessible via opening 73 is preferably not permanently open on its rear side but again covered by an openable lid 67 that can be removed for the purpose of removing some of the electrical contacts 50. This lid 67 now can be swivelled down which is again a preferred solution as the openable lid 67 is nevertheless permanently connected to the connector element 60 and, thus, cannot be lost.

It this embodiment, now only the three upper lines of the busbar can be interrupted. These lines are then preferably used for DALI communication or to provide SELV which lines can be easily interrupted in case the customer decides to realize subsections of a DALI bus or subsections for SELV power supply. In contrast, the contact elements of other lines which shall not be interrupted are permanently protected and cannot be removed.

It should be emphasized that the concept according to the invention has been discussed in relation to a preferred embodiment using busbars that provide uninterrupted contacting capabilities along the entire length of the system. However, the solution according to the invention can also be used with less sophisticated busbar systems that allow contacting of the lines only in certain sections. In these cases, too, the overall system is usually formed by connecting several busbar sections by means of electrical connection means with electrical contacts that allow the connection to be made by a simple plug-in operation. Here, too, it may be necessary to interrupt or split at least some of the lines of the system, which in turn can be realized according to the invention by designing the connecting means in such a way that some of the electrical contacts can be removed.

1. A busbar (110, 120) for luminaires or other electrical devices,
having a plurality of busbar sections which can be connected to one another and which each have a plurality of lines (111, 121), running in a longitudinal direction, for power supply and/or signal transmission, which lines (111, 121) are arranged in grooves (113, 123), open towards a contacting side, of a line-receiving structure (112, 122) consisting of an insulating material,
wherein electrical contacts (50) are arranged in the connecting region of two successive busbar sections, to which contacts (50) in each case the ends of two lines (111, 121) to be connected to one another can be connected and which contacts (50) form a contacting surface (51) accessible from the contacting side,
wherein
that at least one of the electrical contacts (50) is removable in order to interrupt the connection of the corresponding line (111, 121) between two successive busbar sections.

2. The busbar according to claim 1,
wherein
in that a plurality of electrical contacts (50) are arranged in a connector element (60) which has groove-like recesses (61) corresponding to the grooves (113, 123) of the line-receiving structure (112, 122), via which recesses (61) the contacting surfaces (51) of the electrical contacts (50) are accessible.

3. The busbar according to claim 2,
wherein
that the connector element (60) consists of an insulating material.

4. The busbar according to claim 3,
wherein
that the connector element (60) is open or can be opened at its rear side opposite the recesses (61) so as to be able to selectively remove the at least one electrical contact (50).

5. The busbar according to claim 4,
wherein
that the rear side of the connector element (60) is covered by a removable lid (67), preferably by a lid (67) pivotally mounted on the connector element (60).

6. The busbar according to claim 5,
wherein
that the lid (67) is fixed to the connector element (60) in the closed state.

7. The busbar according to claim 4,
wherein
that the connector element (60) is designed in such a way that only a part of the electrical contacts (50) is accessible and thus removable.

8. A trunking rail system (100) for luminaires or other electrical devices,
which comprises a trunking rail profile (101) and at least one busbar (110, 120) held by the trunking rail profile (101) according to claim 1.

9. The trunking rail system according to claim 8,
wherein
in that the trunking rail profile (101) comprises a plurality of trunking rail elements (105) arranged one behind the other, the electrical contacts (50) being arranged in the transition region of two successive trunking rail elements (105).

10. The trunking rail system according to claim 9,
wherein
in that two successive trunking rail elements (105) are mechanically connected to one another by a mechanical connector (70), the removable electrical contact (50) or the connector element (60) being arranged on the mechanical connector (70).

11. The trunking rail system according to claim 10,
wherein
in that the mechanical connector (70) has at least one wall (71, 72) on which the electrical contacts (50) or the connector element (60) are arranged, the side wall (71, 72) having an opening (73) which allows access to the removable electrical contact (50).

12. The trunking rail system according to claim 11,
wherein
that the opening (73) is designed in such a way that only a part of the electrical contacts (50) is accessible and thus removable.

13. The trunking rail system according to claim 10,
wherein
that two successive trunking rail elements (105) in the interconnected state laterally enclose the mechanical connector (70) in such a way that access to the electrical contacts (50) is prevented.

14. The trunking rail system according to claim 8,
wherein
in that the trunking rail profile is U-shaped or H-shaped with two side walls (102), on the inner sides of each of which a busbar (110, 120) is arranged.

15. The trunking rail system according to claim 8,
wherein
in the lines (111, 121) including the removable electrical contacts (50) are used to provide a safety extra low voltage or are used for communication purposes, in particular for the communication according to the DALI standard.
